(19) United States
(12) Patent Application Publication
(10) Pub. No.: US 2017/0210380 A1
(43) Pub. Date: Jul. 27, 2017

(54) FRICTION-COEFFICIENT-DEPENDENT COLLISION AVOIDANCE SYSTEM

(71) Applicant: Conti Temic Microelectronic GmbH, Nürnberg (DE)

(72) Inventor: Stefan Hegemann, Wangen (DE)

(21) Appl. No.: 15/328,971

(22) PCT Filed: Sep. 24, 2015
(86) PCT No.: PCT/EP2015/072005

§ 371 Date: Jan. 25, 2017

(30) Foreign Application Priority Data
Sep. 25, 2014 (DE) 10 2014 219 493.8

(51) Int. Cl. B60W 30/09; B60W 50/14; B60W 40/068; G01S 19/14; G08G 1/16

(52) U.S. Cl. CPC B60W 30/09; G01S 19/14; G08G 1/166; B60W 40/068; B60W 50/14; G01S 19/42

(57) ABSTRACT

A method for adapting a collision avoidance system that avoids a collision of a vehicle with an obstacle, which collision avoidance system is designed to avoid the collision by sensing an actual distance from the obstacle and by outputting a signal on the basis of the falling below of a threshold distance by the actual distance, including: sensing a friction coefficient of an underlying surface on which the vehicle is supported in such a way that the vehicle can be driven, and setting the threshold distance on the basis of the sensed friction coefficient.

### CROSS REFERENCE TO RELATED APPLICATIONS

This application is the U.S. National Phase Application of PCT International Application No. PCT/EP2015/072005, filed Sep. 24, 2015, which claims priority to German Patent Application No. 10 2014 219 493.8, filed Sep. 25, 2014, the contents of such applications being incorporated by reference herein.

### FIELD OF THE INVENTION

The invention relates to a method for adapting a collision warning system, a control device for implementing the method and a vehicle with the control device.

### BACKGROUND OF THE INVENTION

A collision avoidance system is known from DE 10 2012 000 949 A1, incorporated by reference herein in the form of a collision warning system, wherein the driver of a vehicle is warned if there is a risk of collision in order to avoid the collision.

### SUMMARY OF THE INVENTION

An aspect of the invention is an improved collision avoidance system.

According to one aspect of the invention, a method for adapting a collision avoidance system that avoids a collision between a vehicle and an obstacle, which is designed to avoid the collision by measuring an actual distance from the obstacle and issuing a signal based on a shortfall of an actual distance in relation to a threshold distance, comprises the following steps:
Measuring of a friction coefficient of a subsurface on which the vehicle is movably supported, and
setting of the threshold distance based on the measured friction coefficient.

The stated method forms the basis for the deliberation that the threshold distance from which the collision with the obstacle threatens to occur is from a braking distance of the vehicle within which the vehicle can be brought to a standstill without impacting the obstacle. This braking distance is for example dependent on the friction coefficient of the subsurface on which the vehicle is supported. The friction coefficient can change, however, and is not the same everywhere. A fixed value could be used in order to define the threshold distance. The problem here, however, is that it is either no longer possible to avoid all collisions, for example on icy subsurfaces, when the fixed value for the friction coefficient is selected too high, or that the collision avoidance system intervenes too frequently, when for example the subsurface is dry and has a high friction coefficient.

In this regard, the method described above is applied with the recommendation to measure the friction coefficient of the subsurface and set or adapt the threshold distance depending on the measured friction coefficient. In this manner, the collision avoidance system, adapted to different states, can react differently to potential collisions and avoid them more reliably.

Here, the friction coefficient can be measured as required. Most practical here is a database which contains the friction coefficient of the subsurface at different positions. Here, the database fulfills the function of a map, on which the friction coefficients of a road as a subsurface at individual road sections are deposited and stored. The database can be deposited at any point to which the vehicle has information access. Thus, it would be possible to deposit the database in the vehicle itself, but also in a network to which the vehicle has access. A combination is also possible, such as a local database in the vehicle which is then updated at regular intervals from the global database.

In order to measure the friction coefficient, the vehicle can record its position via a global satellite navigation system, for example, and then retrieve the friction coefficient from the database with reference to the recorded position.

In an additional further development, the method described comprises the following steps:
Retrieving information which influences the friction coefficient from at least one further database, and
updating the friction value retrieved from the database based on the information retrieved from the further database.

The information in the further database which influences the friction coefficient can be any information which is suitable for specifying the friction coefficient of the subsurface. Thus, this can comprise weather data, for example, from which it can be seen whether the subsurface has been covered with rain or is even icy.

Alternatively or additionally, the information in the further database which influences the friction coefficient can be information which influences the friction coefficient on the vehicle. For this purpose, vehicle data is deposited in the database such as the material of the wheels, their friction coefficient or chassis properties, on the basis of which the resulting friction coefficient between the subsurface and the vehicle can be estimated as precisely as possible.

Alternatively or additionally, the method described comprises in a further development the step of updating the friction coefficient retrieved from the database, based on at least one item of sensor information.

This sensor information can take any form. It is in any case advantageous that both information from the database and local sensor information are evaluated jointly in order to determine the most precise friction value possible. One possibility would be that the sensor information comprises the state of the windscreen wiper, which in turn allows a prediction as to whether or not it will rain. In this manner, a particularly suitable and simple determination of a friction coefficient would be possible from the combination of the information from the database and the sensor information. An additional or alternative possibility would be that the sensor information originates from a humidity sensor and directly describes the degree of humidity on the road. As a further alternative, the sensor information can also arise from a sensor fusion, however, within the scope of which the information from different sensors is merged to form a single item of sensor information, for example for the purpose of specifying information further.

In general, the sensor information can originate from any sensor within the vehicle.

Alternatively or additionally, however, it would also be possible to receive the sensor information from a sensor outside the vehicle via the network described above, for example. For this purpose, so-called vehicle ad-hoc networks could be used, for example, which can distribute sensor information in the form of messages between the participants or nodes of the vehicle ad-hoc network.

In yet another further development, the method described comprises the following step:
Updating the friction coefficient in the database based on the updated friction coefficient. In this manner, the friction coefficient can be iteratively specified further in the database. In particular in the network described above, this offers the advantage that vehicles which retrieve the updated friction coefficient can achieve precise results with little computing complexity required, wherein the friction coefficient can be maintained at a precise value in the long term through swarm intelligence.

In a particular further development, the collision avoidance system is designed, based on the issued signal, to intervene in the driving dynamics of the vehicle in order to avoid the collision. While the collision avoidance system can react in any way required to the issued signal, and for example warn the driver of the vehicle, so that they initiate the avoidance of the collision by swerving or braking, accidents can also be avoided by active intervention, however, which is elicited for example by insufficient driving skills on the part of the driver. A combination of the previously described reactions to the issued signal would also be possible, whereby the driver is first warned and if they fail to react, an active intervention is made.

According to a further aspect of the invention, a control device is designed to implement one of the methods described.

In a further development of the control device described, the device described comprises a memory and a processor. Here, one of the methods described is stored in the memory in the form of a computer program, and the processor is provided to implement the method when the computer program is loaded from the memory into the processor.

According to a further aspect of the invention, a computer program comprises program code titles in order to implement all steps of the method described when the computer program is implemented on a computer or one of the devices described.

According to a further aspect of the invention, a computer program product contains a program code which is stored on a data carrier which can be read by a computer, and which, when it is implemented on a data processing facility, implements one of the methods described.

According to a further aspect of the invention, a vehicle comprises the following:
A chassis which is movably supported on wheels,
a collision avoidance system which avoids a collision with an obstacle, which is designed to avoid the collision by measuring an actual distance from the obstacle and issuing a signal based on a difference between the actual distance and a set distance, and
one of the described control devices for adapting the collision avoidance system.

### BRIEF DESCRIPTION OF THE DRAWINGS

The properties, features and advantages of this invention described above, and the manner in which these are achieved, become clearer and easier to understand in conjunction with the following description of the exemplary embodiments, which will be explained in greater detail below with reference to the drawings, wherein:

FIG. 1 shows a principle representation of a vehicle on a road, and

FIG. 2 shows a principle representation of a merging sensor in the vehicle shown in FIG. 1.

### DETAILED DESCRIPTION OF THE PREFERRED EMBODIMENTS

In the figures, the same technical elements are assigned the same reference numerals and are described only once.

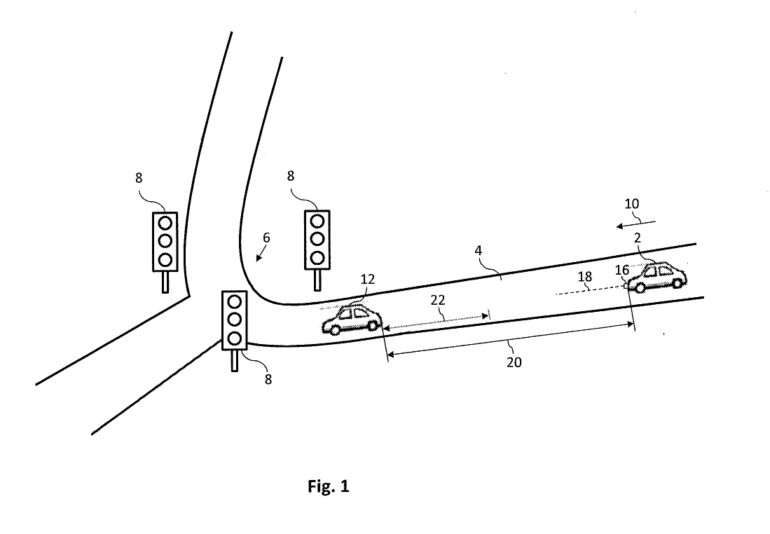

Reference is made to FIG. 1, which shows a principle representation of the vehicle 2 on a road 4.

Within the scope of the present embodiment, the vehicle 2 drives towards a crossroads 6, on which the traffic is regulated via a signal system with three traffic lights 8. By way of explaining the present exemplary embodiment, it should here be assumed that the vehicle 2 is moving in a driving direction 10 on the road 4 towards one of the traffic lights 8, and that another vehicle 12 is waiting in front of this traffic light 8.

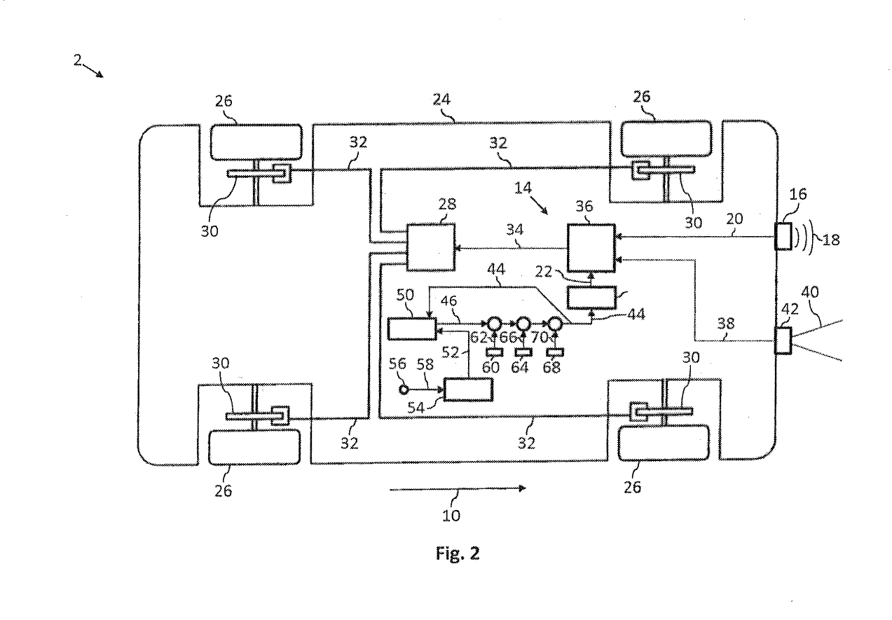

Within the scope of the present embodiment, the vehicle 2 has a collision avoidance system, yet to be described, in the form of a brake assistant referenced in FIG. 2. The brake assistant 14 uses a sensor, such as a radar sensor 16 with radar rays 18, to measure an actual distance 20 from the other vehicle 12, and if this actual distance 20 falls below a threshold distance 22 to the other vehicle 12, the brake assistant 14 automatically brakes the vehicle 2.

This will be described in detail further below. First, the vehicle 2 will be described in greater detail below with reference to FIG. 2.

The vehicle 2 comprises a chassis 24 which in the generally known manner is movably supported via wheels 26 on a subsurface such as the road 4. The wheels 26 can be braked individually for each wheel by a generally known brake control mechanism 28 via brakes 30, via triggering with brake control signals 32 based on a brake command 34. This brake command 34 can be generated by a plurality of technical mechanisms in the vehicle 2, such as a brake pedal controlled by the driver. In the present embodiment, however, the brake command 34 is generated by the brake assistant 14.

The brake assistant 14 comprises a trigger mechanism 36, which essentially generates the brake command 34 based on a comparison of the actual distance 20 and the threshold distance 22. This is generally known and does not require further explanation. Within the scope of the present invention, the radar sensor 16 is shown as issuing the actual distance 20. As a rule, the actual distance 20 in the trigger mechanism 36, taking into account additional sensor information, such as the camera image 38 of an image 40 of a camera 42, is in the driving direction 10 in front of the vehicle 2. Details on the subject can be found in the relevant prior art.

Within the scope of the present invention, the threshold distance 22 depends on a friction coefficient 44, also known as a friction factor or friction value, which describes a friction between the wheels 26 of the vehicle 2 and the road 4. The friction coefficient 44 is here advantageously determined as precisely as possible on the route between the vehicle 2 and the other vehicle 12. For this purpose, a calculation instrument 46 is provided which can determine the braking distance of the vehicle 2 on the road 4 from the friction coefficient 44, and based on this, the threshold distance 22, which is necessary in order to bring the vehicle 2 to a standstill via the brakes 30 without colliding with the other vehicle 12.

The basis for the friction coefficient 44 is in the present embodiment an initial friction coefficient 48, which can be stored in a database 50 depending on a position 52 of the vehicle 2 in the form of map data. This database 50 can in general also be arranged outside of the vehicle 2 and be queried, for example, via wireless network communication.

The position 52 can for example be received from a receiver 54 for a global satellite navigation system, or GNSS, which receives a GNSS signal 58 via an antenna 56 and from this determines the position 52 of the vehicle 2 in the generally known manner. Alternatively, the position can also be determined with other sensors, however, such as a fusion sensor.

The initial friction coefficient 48 can now be adapted in many different ways to the conditions on the road 4. For this purpose, for example, sensor information 62 from a sensor 60, such as a humidity sensor, can be retrieved which describes the state of the road 4 in relation to the actual friction coefficient 44. If the road 4 is wet, for example, the initial friction coefficient 48 can be reduced accordingly in order to determine the friction coefficient 44. As additional or alternative sensor information, the status of a windscreen wiper of the vehicle 2, which is not shown further, could be queried for example. If the windscreen wiper is on, it can be concluded that there is a wet road 10.

Further, a vehicle memory 64 can be read, which can contain vehicle-specific data 66 such as material properties of the wheels 26, chassis data regarding the vehicle 2, or other data which influences the friction coefficient 44. Based on this data 66, the initial friction coefficient 48 can also be adapted.

Finally, the road state 70 of the road 10 can also be queried from an additional database 68. This database 68 can for example be a weather map or information database, which provides information about the material from which a road surface of the road 10 is made. Like the database 50, the additional database 68 can also be arranged internally in the vehicle 2 or externally outside the vehicle 2.

Several additional databases 68 can also be present, wherein each additional database is provided by a different service provider. The weather map could be provided by a weather report provider, while the state or local authority could offer data on the road surface. The vehicle-specific data 66 could also be provided as an additional database, which can then be offered by the vehicle manufacturer and their suppliers for use by the local community.

In order to limit the computing complexity for the friction coefficient 44′, a currently determined friction coefficient 44 can be stored as the next initial friction coefficient 48 to a current position 52 in the database 50.

1. A method for adapting a collision avoidance system that avoids a collision between a vehicle and an obstacle, which is designed to avoid the collision by measuring an actual distance from the obstacle and issuing a signal based on a shortfall of an actual distance in relation to a threshold distance, comprising:
measuring of a friction coefficient of a subsurface on which the vehicle is movably supported, and
setting of the threshold distance based on the measured friction coefficient.

2. The method according to claim 1, wherein the friction coefficient is determined based on a retrieval from a database, in which a base value is stored dependent on the position for the friction coefficient.

3. The method according to claim 2, wherein the database is deposited in a network to which the vehicle is connected.

4. The method according to claim 2, further comprising:
retrieving information which influences the friction coefficient from at least one further database, and determining the friction coefficient based on the information retrieved from the at least one further database and the base value.

5. The method according to claim 2 comprising:
Determining the friction coefficient based on the base value retrieved from the database and at least one item of sensor information.

6. The method according to claim 5, wherein the sensor information is received from a sensor outside of the vehicle or a sensor within the vehicle.

7. The method according to claim 4, further comprising:
updating the base value for the friction coefficient in the database based on the determined friction coefficient.

8. The method according to claim 1, wherein the collision avoidance system is designed, based on the issued signal, to intervene in the driving dynamics of the vehicle in order to avoid the collision.

9. A control device for implementing a method according to claim 1.

10. A vehicle comprising:
a chassis which is movably supported on wheels,
a collision avoidance system that avoids a collision with an obstacle, which is designed to avoid the collision by measuring an actual distance from the obstacle and issuing a signal based on a shortfall of an actual distance in relation to a threshold distance, and
control device according to claim 9 for adapting the collision avoidance system.

11. The method according to claim 3, further comprising:
retrieving information which influences the friction coefficient from at least one further database, and
determining the friction coefficient based on the information retrieved from the at least one further additional database and the base value.

12. The method according to claim 5, further comprising:
updating the base value for the friction coefficient in the database based on the determined friction coefficient.
